(19) United States
(12) Patent Application Publication
(10) Pub. No.: US 2022/0005375 A1
(43) Pub. Date: Jan. 6, 2022

(54) VIOLIN TRAINING APPARATUS AND PROCESS

(71) Applicant: BRUCE ALLEN CARTER, MIAMI BEACH, FL (US)

(72) Inventor: BRUCE ALLEN CARTER, MIAMI BEACH, FL (US)

(21) Appl. No.: 17/281,654

(22) PCT Filed: Oct. 3, 2018
(86) PCT No.: PCT/US2018/054150

§ 371 Date: Mar. 31, 2021

(51) Int. Cl. G09B 15/06; G10D 1/02; G10D 3/166

(52) U.S. Cl. CPC G09B 15/06; G10D 3/18; G10D 3/166; G10D 1/02

(57) ABSTRACT

A violin and bow training apparatus having a bow guide and a guide housing that is adjustable to accurately mimic the bow stroke angle for the four strings of the violin G, D, A, and E is provided.

### FIELD OF THE INVENTION

This invention is directed towards a violin and bow teaching apparatus that teaches proper hand and arm motions for string instruments. The training apparatus has a swiveling bow guide on the center of the training instrument and provides a introduction to string study in three distinct ways: 1) the instrument is virtually indestructible and can be painted and drawn on; 2) the low cost allows students to try an instrument with little economic downside; 3) solid foundational movements are encouraged and muscle memory is developed in ways that make transitioning to a traditional instrument easier.

### BACKGROUND OF THE INVENTION

This invention relates generally to an apparatus and process for teaching the proper techniques for playing stringed instruments such as a violin. The violin and viola are distinctive among acoustical instruments in how they are physically held and played. The instrument is placed on the left shoulder, slightly under the chin, and fingered with the left hand, while the right hand operates the bow. This positioning can present what seem to be insurmountable challenges for a beginner string student. What makes string education unique is the focus on fine motor skills that must be mastered so that tone (right hand) and intonation (left hand) are controlled. Beginning string instrument must be kinesthetic in nature to be successful.

One device known in the art can be seen in reference to US Patent Application Publication US2009/0211432 published on Aug. 27, 2009, and which is incorporated herein by reference. While the musical instrument trainer referenced therein provides for some practice movements useful for bow instruments, there remains room for variation and improvement within the art.

### SUMMARY OF THE INVENTION

It is one aspect of at least one of the present embodiments to provide for a violin and bow training apparatus having a bow guide and a guide housing that is adjustable to accurately mimic the bow stroke angle for the four strings of the violin G, D, A, and E.

It is a further aspect of at least one of the present embodiments to provide for a violin and bow training apparatus having an ergonomically designed shoulder rest and chin rest.

It is a further aspect of at least one of the present embodiments of the invention to provide for a violin and bow training apparatus having a fingerboard with spaced indentations that teach the proper placement for notes in reference to the first position.

It is a further aspect of at least one embodiment of the present invention to provide for a violin and bow training apparatus having an intermediate grip portion that provides new students with a way of learning to hold the instrument that will allow proper balance and proper left arm form.

It is a further aspect of at least one embodiment of the present invention to provide for a violin and bow training apparatus having a removable shoulder and chin rest which can be replaced with different sizes in order to accommodate an individual's needs.

It is a further aspect of at least one embodiment of the present invention to provide for a violin and bow training apparatus in which there is a bow guide housing having indented notches that allows the bow guide to snap into proper angles that mimic the G, D, A, and E string bow positioning. It is a further aspect of at least one embodiment of the present invention to provide for a violin and bow guide that allows for finger indentations for the left hand on the bow hold in order to conform to a finger position on the violin, the apparatus further defining an indent to show proper thumb placement of the right hand.

It is a further aspect of at least one embodiment of the present invention to provide, as illustrated in the Figures, a training apparatus 10 for a violin or viola comprising or consisting of:

a support frame 50, the support frame 50 having a first end and a second end;

a support base 90 supported by a first end of the support frame 50, the support base 90 having a chin rest 30 on an upper surface of the support base 90 and a shoulder rest 40 on a lower surface of the support base 90, the chin rest 30 further defining a plurality of indentations on an upper service of the chin rest 30, the chin rest 30 being movable into a plurality of positions relative to the support base 90;

a bow guide housing 80 positioned above an upper surface of the frame 50, the bow guide housing 80 supporting a bow guide 20 that defines an enclosure adapted for receiving a bow 22, the bow guide 20 being positioned within the bow guide housing in 4 defined alignment paths corresponding to positionings of strings positions for strings “G”, “D”, “A” and “E”;

a fingerboard 70, having an upper surface defining a plurality of protrusions, the protrusions corresponding to a location for proper placement of a user's fingers, the fingerboard 70 secured to the bow guide 80 and is further secured to the support frame 50.

It is a further aspect of at least one embodiment of the present invention to a method of teaching playing of a stringed instrument such as violin comprising:

providing a training apparatus 10, the training apparatus comprising a training apparatus 10 for a violin comprising:

a support frame 50, the support frame 50 having a first end and a second end;

a support base 90 supported by a first end of the support frame 50, the support base 90 having a chin rest 30 on an upper surface of the support base 90 and a shoulder rest 40 on a lower surface of the support base 90, the chin rest 30 further defining a plurality of indentations on an upper service of the chin rest 30, the chin rest 30 being movable into a plurality of positions relative to the support base 90;

a bow guide housing 80 positioned above an upper surface of the frame 50, the bow guide housing 80 supporting a bow guide 20 that defines an enclosure adapted for receiving a bow 22, the bow guide 20 being positioned within the bow guide housing in four defined alignment paths corresponding to positionings of strings positions for strings “G”, “D”, “A” and “E”;

a fingerboard 70, having an upper surface defining a plurality of protrusions, the protrusions corresponding to a location for proper placement of a user's fingers, the fingerboard 70 secured to the bow guide 80 and is further secured to the support frame 50;

placing the training apparatus onto a person's body such that the chin rest 30 engages a user's chin and the shoulder rest 40 engages a user's shoulder;

placing the person's right hand onto the bow grip;

placing the person's left hand onto the finger board;

placing, the bow guide into one of the plurality of alignment paths; and

moving the bow within the bow housing.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is an upper left perspective view of an embodiment of a string, instrument training apparatus for a violin or viola.

FIG. 2 is an upper right perspective view of the training apparatus seen in FIG. 1.

FIG. 3 is a perspective view of a portion of the training apparatus seen in FIGS. 1 and 2 setting forth details, of the bow guide housing and bow guide.

FIG. 4 is a side view of the training apparatus in which the bow portion has been removed and illustrating additional details of the training apparatus.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

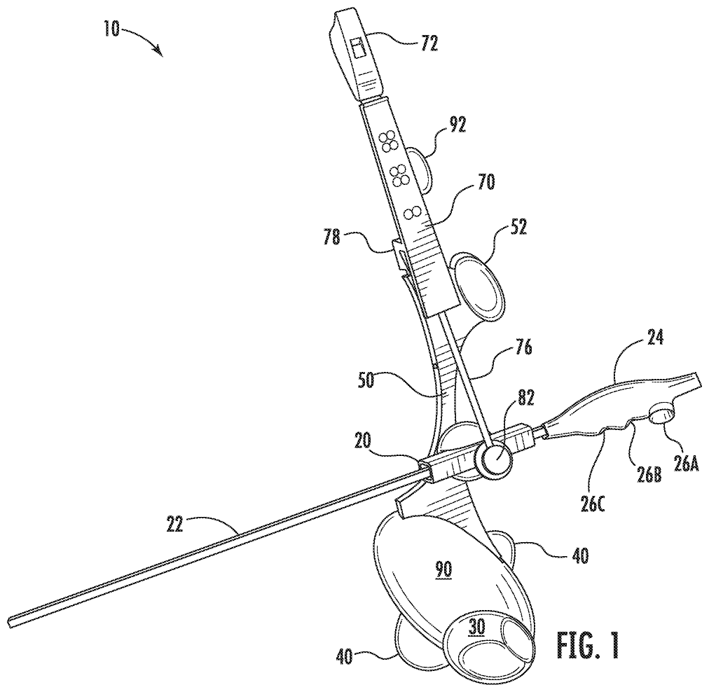

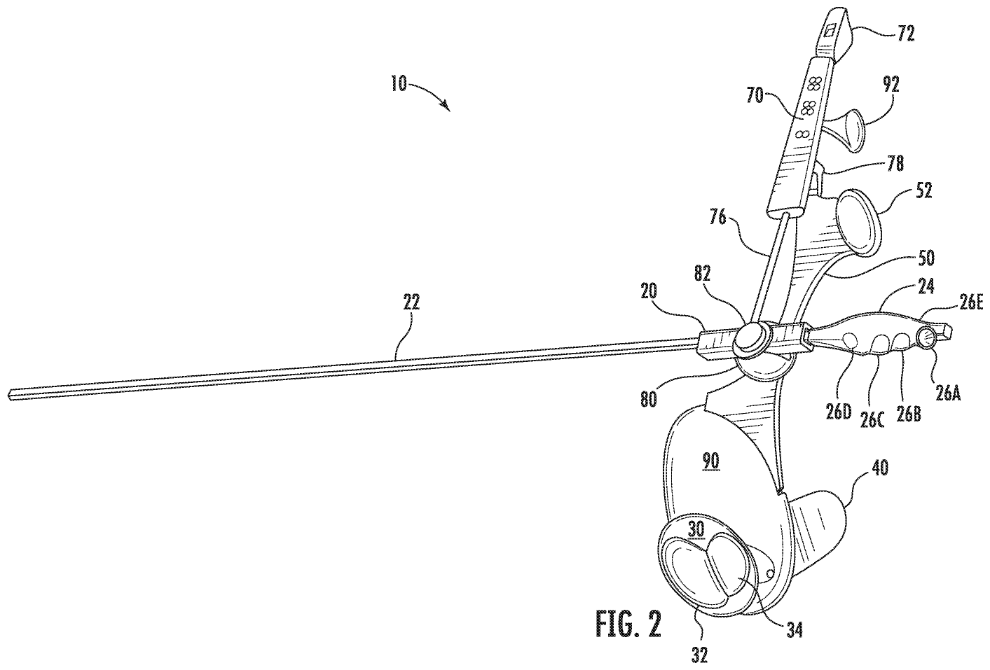

As best seen in reference to FIGS. 1 and 2, a training apparatus 10 for a string instrument such as a violin or a viola is provided having a support frame 50, the support frame having a first end and a second end. Attached to a first end of the support frame 50 is a support base 90, the support base 90 having a chin rest 30 on an upper surface of the support base 90 and a shoulder rest 40 on a lower surface of the support 90. The chin rest 30 may define a plurality of indentations on an upper surface of the chin rest 30. In a preferred embodiment, the chest rest 30 may be rotated into a plurality of positions relative to the support base 90. As the chin rest 30 is rotated, the height of the chin rest relative to the support base is also varied. In this manner, a comfortable and proper placement of the chin rest relative to a user is obtained.

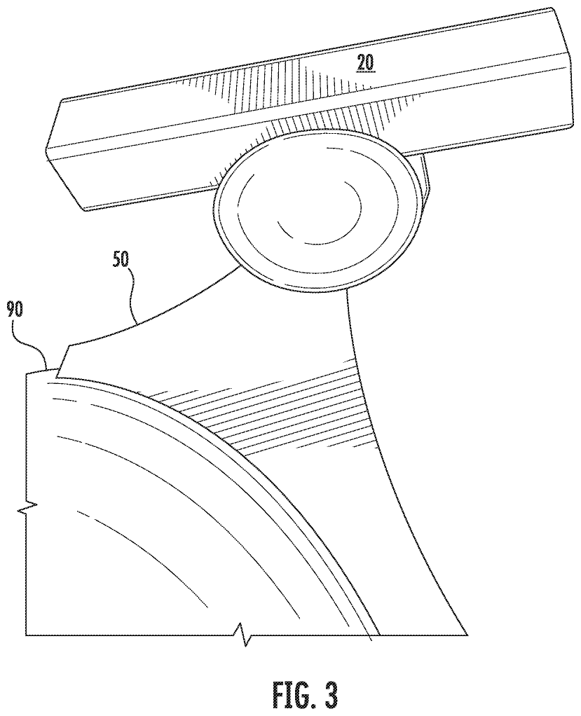

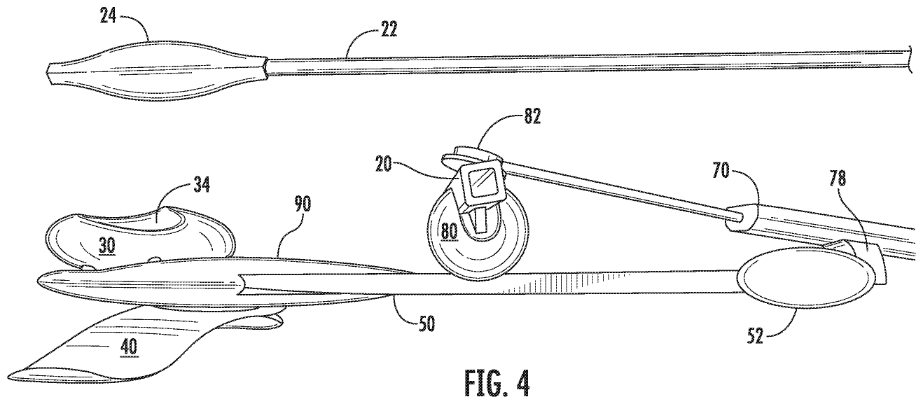

As further seen in reference to FIGS. 1 and 2, a bow guide housing 80 is positioned on an upper surface of the frame 50, the bow guide housing 80 supporting a bow guide 20 that defines an enclosure adapted for receiving a bow 22, The bow guide 20 is pivotable into various preset alignment paths through a series of notches and detents formed between the bow guide housing 80 and the bow guide 20. The alignment path corresponds to proper placement of the bow for the string positions for “a”, “D”, “A” and “E”. The alignment paths and pivoting structure are additionally seen in reference to FIGS. 3 and 4.

As seen in FIGS. 1 and 2 a fingerboard 70 is attached to a rear portion of the support frame 50 such that the fingerboard 70 is maintained in an elevated position above the support frame 50. Additionally, a first end of the fingerboard is shown having a circular extension which is inserted into a securement member 82 that is secured to guide housing 80. In this manner, the fingerboard 70 is supported through an attachment point that connects a lower surface of the fingerboard 70 to a rear portion of the frame 50, the fingerboard 70 being further supported along the first end by placement within a securing member 82. As further seen in reference to FIGS. 1 and 2, bow 22 defines along one terminal end a hold member 24. Hold member 24 defines a plurality of indentations 26A-E in which indentations 26A-D provide for placement of the user's fingers and 26D providing a slight depression for proper placement of a user's thumb. As illustrated, indentation 26A is a more circular depression and is designed for receiving the pinky finger of a user as the user's right hand is placed over the top of the bow guide as seen in the orientation of FIGS. 1 and 2.

As further seen in reference to FIGS. 1 and 2, an optional palm guide 52 can be provided that extends from a side of the support frame 50. The palm guide 52 may be used with or without the fingerboard 70 attached but helps provide an intermediate hold position for proper alignment of the user's shoulder, elbow, and wrist such as to impart a proper alignment, positioning, and muscle memory that is useful for learning proper playing of the instrument.

An additional optional feature seen in FIGS. 1 and 2 is a slide whistle 72 that is insertable within a free end of the fingerboard 70. The slide whistle 72 can be used when the fingerboard 70 is detached from the frame 50 and the guide housing 80 to allow a student to practice use of a slide whistle.

An additional optional feature includes a palm cup 92 that extends to one side of the fingerboard 70 to which it is reversibly attached. The palm cup 92 is a practice device that allows a student to develop a proper hand shape which involves maintaining a cupped palm position. Such positioning is sometimes referred to as a “water hold” in that the user should cup a hand in a way one would use to cup water in a palm. This hand position is one that is utilized when engaging the hold member 24 and can be a useful accessory to the training apparatus.

The components described above are preferably formed from a 3D printing process and can also be formed by other traditional molding techniques. The use of a 3D printing process has been found to offer extremely durable parts. Ideally, the fingerboard 70 component is detachable from the guide housing and the support frame 50. Similarly, the guide housing 80 can be removed from the support frame 50 as can the shoulder rest 40 and the chin rest 30. Similarly, the palm cup 92 and palm guide 52 can also be detachable. The detachable nature allows for the instrument to be stored more compactly and more easily transported. In addition, it also allows for a selection of various sizes of a shoulder rest 40, a chin rest 30, or hold member 24 to accommodate customization of the training apparatus to any one individual.

The violin/viola requires a student to coordinate both the left and right hands, while engaged in completely different functions, each presenting their own exceptional challenges. The left hand is used to finger the notes. Unlike the guitar, the violin has no frets to guide the player in the positioning of their fingers. The intonation of the instrument, or the ability to play in tune, rests with the placement of the fingers of the left hand. It takes steady practice to develop the muscle memory to ensure correct placement of the fingers.

As seen in, reference to FIGS. 1 and 2, to assist with this learning, an indented fingerboard 70 is pivoted to guide young players to correct finger placement in first position (the first set of finger placements a student must learn). Additionally, a left hand palm guide 52 is optionally pivoted to form provide paper positioning of the left hand and left arm.

The right hand controls the bow. The bow is drawn across the strings vibrating them, and sounds the notes being held with the fingers of the left hand. Proper bow technique can be difficult at first. Again, it requires muscle memory to apply the correct speed and pressure with the bow, while coordinating the fingers of the left hand. The smallest variations of speed or pressure can drastically affect the tone of the instrument. Developing this skill is often said to be the most difficult technique to master.

The violin and bow training apparatus has been designed to provide “training wheels” for string playing that leads to music production on traditional wooden violins. The tool accelerates complex and nuanced kinesthetic movements that are often difficult in the first few months of traditional study. The violin and bow training apparatus fosters numerous correct markers of both right and left hand technique in addition to assisting in correct body alignment, including heard, shoulder, and elbow placement in the left arm. For the right hand (bow arm), numerous markers of correct movement and hold, are encouraged through raised protrusions of the hold 24 of the rotational bow 22 (the stick).

The instrument has been designed for comfort with purposeful intention towards making the lightest instrument possible. The instrument facilitates correct body alignment in addition to fostering early foundational movements that lead to superior tone production (right hand) and proper intonation (left hand).

First, the shoulder rest area has been ergonomically designed so that it fits comfortably in the shoulder/chin area of the student. The chin rest on a traditional wooden, instrument is non adjustable and usually requires an additional purchase of a tool to help support the instrument during play. This instrument has an upper and lower part designed to help support the violin and develop correct head and shoulder alignment. Additionally, both the upper and lower portions can be snapped off and replaced with various lengths to help customize the size of the area. This is critical as neck length can vary drastically and having a comfortable fit is important in maintaining comfort and balance.

For example, as students grow more relaxed in their bow stroke, various components around the bridge section can be adjusted so increasing autonomy can be achieved and demonstrated. Similarly, in the left hand, 3D printed slides can help students identify where to put their fingers in first position, and be removed as students grow more confident in their abilities.

The violin of the present invention can be provided from a number of materials including the use of 3D printing materials or can be formed of a molded plastic or resin material. To the extent the training device violin is designed to help beginners learn proper positioning of fingers in the instrument, more durable materials such as wood are not needed sand is believed that lightweight materials such as plastics, nylon, and other thermoformable plastics are desired.

The training apparatus described provides for a teaching violin comprising:

a violin having a fingerboard having multiple indentations for proper positioning of fingers;

a grip portion defined by a body of the violin that provides for a proper balance and arm form; and

an adjustable bow guide having indented notches that allows for proper angles that mimic the G, D, A, & E string.

The training apparatus described provides for a teaching apparatus according to wherein the teaching apparatus further defines a palm cup 92 that is positioned along side an edge of the fingerboard 70.

The teaching apparatus further defines a palm guide, the palm guide being positioned along side an edge of the support frame, wherein when a user places their right hand on the palm guide, the palm guide places the user's arm, elbow, and wrist in a desired orientation with respect to the training apparatus 10.

The training apparatus provides a bow guide that has an interior enclosure for receiving the bow, the bow guide enclosure formed by a plurality of straight walls.

The apparatus further provides a bow guide housing, and the bow guide housing defines a plurality of detents for reversibly securing the bow guide in a desired position.

The training apparatus provides for a structure wherein at least one of the fingerboards 70, the bow housing 80, and the support base 90 are detachable from the support frame 50.

The support frame 50 defines a substantially flat upper surface and a substantially flat lower surface, and wherein the fingerboard 70 provides for at least three distinct groupings of protrusions present on the upper surface of the fingerboard, the protrusions corresponding to proper positioning of a user's fingers relative to a location of a string on a violin.

The training apparatus provides a free end of the fingerboard which defines an opening for receiving a slide whistle.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention as set forth herein. In addition, it should be understood that aspects of the various embodiments may be interchanged, both in whole, or in part. Therefore, the spirit and scope of the invention should not be limited to the description of the preferred versions contained therein.

1. A training apparatus 10 for a violin comprising:
a support frame 50, the support frame 50 having a first end and a second end;
a support base 90 supported by a first end of the support frame 50, the support base 90 having a chin rest 30 on an upper surface of the support base 90 and a shoulder rest 40 on a lower surface of the support base 90, the chin rest 30 further defining a plurality of indentations on an upper service of the chin rest 30, the chin rest 30 being movable into a plurality of positions relative to the support base 90;
a bow guide housing 80 positioned above an upper surface of the frame 50, the bow guide housing 80 supporting a bow guide 20 that defines an enclosure adapted for receiving a bow 22, the bow guide 20 being positioned within the bow guide housing in 4 defined alignment paths corresponding to positionings of strings positions for strings “G”, “D”, “A” and “E”;
a fingerboard 70, having an upper surface defining a plurality of protrusions, the protrusions corresponding to a location for proper placement of a user's fingers, the fingerboard 70 secured to the bow guide 80 and is further secured to the support frame 50.

2. A method of teaching playing of a stringed instrument such as violin comprising:
providing a training apparatus 10, the training apparatus comprising A training apparatus 10 for a violin comprising:
a support frame 50, the support frame 50 having a first end and a second end;
a support base 90 supported by a first end of the support frame 50, the support base 90 having a chin rest 30 on an upper surface of the support base 90 and a shoulder rest 40 on a lower surface of the support base 90, the chin rest 30 further defining a plurality of indentations on an upper service of the chin rest 30, the chin rest 30 being movable into a plurality of positions relative to the support base 90;
a bow guide housing 80 positioned above an upper surface of the frame 50, the bow guide housing 80 supporting a bow guide 20 that defines an enclosure adapted for receiving a bow 22, the bow guide 20 being positioned within the bow guide housing in 4 defined alignment paths corresponding to positionings of strings positions for strings “G”, “D”, “A” and “E”;
a fingerboard 70, having, an upper surface defining a plurality of protrusions, the protrusions corresponding to a location for proper placement of a user's fingers, the fingerboard 70 secured to the bow guide 80 and is further secured to the support frame 50;
placing the training apparatus onto a person's body such that the chin rest 30 engages a user's chin and the shoulder rest 40 engages a user's shoulder;
placing the person's right hand onto the bow grip;
placing the person's left hand onto the finger body;
placing the bow guide into of the plurality of alignment paths; and
moving the bow within the bow housing.

3. The apparatus according to claim 1 wherein the teaching apparatus further defines a palm cup 92 that is positioned along side an edge of the fingerboard 70.

4. The teaching apparatus according to claim 1 wherein the teaching apparatus further defines a palm guide, the palm guide being positioned along side an edge of the support frame, wherein when a user places their right hand on the palm guide, the palm guide places the user's arm, elbow, and wrist in a desired orientation with respect to the training apparatus 10.

5. The training apparatus according to claim 1 wherein the bow guide has an interior enclosure for receiving the bow, the bow guide enclosure formed by a plurality of straight walls.

6. The apparatus according to claim wherein the bow guide pivots within the bow guide housing.

7. The training, apparatus according to claim 1 wherein the bow guide housing, defines a plurality of detents for reversibly securing the bow guide in a desired position.

8. The training apparatus according to claim 1 wherein at least one of the fingerboards 70, the bow housing 80, and the support base 90 are detachable from the support frame 50.

9. The training apparatus according to claim 1 wherein the support frame 50 defines a substantially flat upper surface and a substantially flat lower surface.

10. The training apparatus according to, claim 1 wherein the fingerboard 70 provides for at least three distinct groupings of protrusions present on the upper surface of the fingerboard, the protrusions corresponding to proper positioning of a user's fingers relative to a location of a string on a violin.

11. The training apparatus according to claim 1 wherein a free end of the fingerboard defines an opening for receiving a slide whistle.

12. A teaching violin comprising:
a violin having a fingerboard having multiple indentations for proper positioning of fingers;
a grip portion defined by a body of the violin that provides for a proper balance and arm form; and
an adjustable bow guide having indented notches that allows for proper angles that mimic the G, D, A, & E string.
